(19) United States
(12) Patent Application Publication
(10) Pub. No.: US 2011/0081217 A1
(43) Pub. Date: Apr. 7, 2011

(54) Expansion anchor

(75) Inventors: Matthias Wissling, St. Gallen (CH); Marc Schaeffer, Feldkirch-Nofels (AT)

(73) Assignee: Hilti Aktiengesellschaft, Schaan (LI)

(21) Appl. No.: 12/924,755

(22) Filed: Oct. 5, 2010

(30) Foreign Application Priority Data
Oct. 6, 2009 (DE) DE102009045345.8

(51) Int. Cl. F16B 13/06

(52) U.S. Cl. 411/45

(57) ABSTRACT

A multi-part expansion anchor (11) has, as a first part, an expansion sleeve (31) which has, as its elements, several expansion tabs (35) that are separated from each other by elongated slots (34) and has, as a second part, an expansion body (21) that can be pulled into the expansion sleeve (31), and a conical portion (22) for purposes of radially widening the expansion sleeve (31). The conical portion (22) has, as its elements, edges (24) running along the longitudinal axis (13). One of the parts of the expansion anchor (11) has an even number of appropriate elements, while the other part of the expansion anchor (11) has an odd number of appropriate elements.

This claims the benefit of German Patent Application DE 10 2009 045 345.8, filed Oct. 6, 2009 and hereby incorporated by reference herein.

The invention relates to a multi-part expansion anchor.

### BACKGROUND

Such multi-part expansion anchors are used in a drilled hole that has been previously made in a substrate, for example, in a wall, floor or ceiling of a structure. When the expansion body is pulled into the expansion sleeve, the latter is widened radially and the expansion anchor is anchored in the substrate.

European patent application EP 1 243 801 B1 discloses a multi-part expansion anchor that, as a first part, has an expansion sleeve which has, as its elements, several expansion tabs that are separated from each other by elongated slots and that, as a second part, has an expansion body that can be pulled into the expansion sleeve and that has a conical portion for purposes of radially widening the expansion sleeve, whereby the conical portion has, as its elements, edges running along the longitudinal axis. The number of edges of the expansion body running along the longitudinal axis corresponds to the number of expansion tabs of the expansion sleeve, as a result of which each element of the expansion sleeve is guided between the edges by the cone surfaces.

A drawback of the prior-art approach is that, due to the contact that the expansion tabs make with the cone surfaces between the edges, a great deal of installation force is required in order to radially widen the expansion sleeve.

### SUMMARY OF THE INVENTION

It is an object of the present invention to create an expansion anchor that is easy to install and that has high pull-out strength.

The present invention provides a multi-part expansion anchor that, as a first part, has an expansion sleeve which has, as its elements, several expansion tabs that are separated from each other by elongated slots and that, as a second part, has an expansion body that can be pulled into the expansion sleeve and that has a conical portion for purposes of radially widening the expansion sleeve, whereby the conical portion has, as its elements, edges running along the longitudinal axis, characterized in that one of the parts of the expansion anchor has an even number of appropriate elements, while the other part of the expansion anchor has an odd number of appropriate elements.

The different number of elements ensures that, when the expansion body is being pulled into the expansion sleeve, the sleeve only rests at certain points on the conical portion of the expansion body. This minimizes the friction surface and thus the initial inner friction—as the integration of the frictional stresses over the friction surface between the expansion body and the expansion sleeve—so that much less installation force is needed to anchor the expansion anchor in the drilled hole than is the case with a conventional expansion anchor. There is no need to install a separation layer in order to ensure a low initial static friction between the expansion body and the expansion sleeve. Moreover, the low initial static friction hinder or prevents the expansion sleeve from turning along in the drilled hole at the beginning of the installation process or when the expansion body starts to be pulled into the expansion sleeve.

The conical portion of the expansion body can have a polygonal cross section. In this context, the term cross section refers to the cross section of the expansion body that spans a plane on which the longitudinal axis of the expansion anchor stands perpendicularly. The cross section of the portions between the edges of the conical portion of the expansion body are curved and/or straight. Preferably, the cross section of the conical portion of the expansion body is polygonal and also advantageously has portions of equal length between adjacent edges.

Since the expansion sleeve—even during the radial widening—need not be in contact with the entire surface of the conical portion of the expansion body, there can be gaps between the expansion sleeve and the expansion body into which drilling dust can enter in an advantageously defined manner. The drilling dust that has entered the gap—especially towards the end of the pulling-in process—increases the friction between the expansion sleeve and the expansion body, thus ensuring greater security in the installed state against the expansion body slipping through the expansion sleeve under load. Advantageously, the ratio between the part with the even number of elements and the part with the odd number of elements is 1.5:1 to 4.0:1, especially 2.0:1 to 3.0:1. For example, the part with the even number has eight elements and the part with the odd number has three elements. In another, not definitive version, the part with the even number has six elements and the part with the odd number has three elements.

Moreover, in a variant not encompassed by the present invention, expansion anchors are advantageous in which the two parts of the expansion anchor each have an even number of elements or an odd number of elements as well as the above-mentioned ranges of ratios. For example, one part has eight or six elements, and the other part has two elements.

Preferably, the expansion bodies have an even number of edges running along the longitudinal axis, and the expansion sleeve has an odd number of expansion tabs, thereby ensuring that the expansion anchor can easily be manufactured as a mass-produced item.

As an alternative, the expansion body has an odd number of edges running along the longitudinal axis while the expansion sleeve has an even number of expansion tabs.

Preferably, the cross section of the conical portion of the expansion body has a maximum outer circle diameter that is formed by the edges running along the longitudinal axis and that is 0.8 to 1.4 times the value of a maximum outer circle diameter defined by the expansion sleeve, as a result of which greater pull-out strength can be achieved with the same or even less installation force than in the case of a conventional expansion anchor. Moreover, with the expansion anchors according to the invention, the pull-out strength is much less dependent on the geometry of the drilled hole than in the case of a conventional expansion anchor. In this context, the term maximum outer circle diameter of the expansion sleeve refers to the diameter of the enveloping circle that surrounds the outer wall as well as any projections that might be present such as retaining lugs and the like. Particularly with an expansion sleeve without projections, the maximum outer circle diameter of the expansion body is advantageously 0.9 to 1.1 times the value of the maximum outer circle diameter defined by the expansion sleeve, whereby this ratio is especially advantageous in hard substrates such as, for example, concrete. If the expansion anchor is specially configured for soft substrates such as, for example, aerated concrete, then a larger ratio can also be selected, in which the maximum outer circle diameter of the expansion body is advantageously 1.1 to 1.3 times the value of the maximum outer circle diameter defined by the expansion sleeve.

Preferably, the edges of the conical portion of the expansion body running along the longitudinal axis are curved, as a result of which a simple expansion of the expansion sleeve is ensured and thus relatively little installation force is needed to install the expansion anchor. Advantageously, the edges running along the longitudinal axis are curved outwards or are convex towards the outside relative to the longitudinal axis of the expansion anchor, so that the requisite installation force for installing the expansion anchor increases towards the end of the installation process, and as a result, the user can clearly feel when the expansion anchor has been completely anchored in the drilled hole. This measure also advantageously prevents unintentional over-tightening as a result of applying an excessive torque, and furthermore, the installed expansion anchor undergoes an advantageous subsequent expansion, especially in a cracked substrate. As an advantageous alternative, the edges running along the longitudinal axis are curved inwards or are concave towards the outside relative to the longitudinal axis of the expansion anchor, so that the requisite installation force can likewise be influenced. In another embodiment, different configurations of the edges running along the longitudinal axis, for example, linear, running curved towards the outside and/or towards the inside, can be combined in an expansion body.

Preferably, the expansion body is torsioned, i.e. twisted, along the longitudinal axis, at least in the area of the conical portion, as a result of which the inside of the expansion sleeve always makes contact with areas that are radially opposed to each other when the expansion body is being pulled in, and it is then correspondingly widened. This ensures a simple and advantageous radial widening of the expansion sleeve and prevents, for example, one edge from becoming lodged in a slot between the expansion tabs.

Preferably, the expansion body is provided on one free end of a stud body and the expansion sleeve surrounds the stud body, at least in certain areas, so that the user is provided with a multi-part expansion anchor as an assembly part. Such expansion anchors are also referred to as stud anchors.

In a variant of the invention, the expansion body has a connecting means for a stud element that can be fastened onto the expansion body subsequently, depending on the requirements in question.

Preferably, the connecting means comprises a bore in the expansion body in which a fastening means is provided for the stud element, as a result of which the stud element can be fastened onto the expansion body without affecting the expansion sleeve. Advantageously, the fastening means is an internal thread into which an external thread of the stud element can be screwed. Thus, for example, a rod element can be used as the stud element that, if necessary, has been cut to the proper length and that has an external thread such as, for example, a threaded rod.

Preferably, the expansion anchor is already fitted ex factory with a stud element that is joined to the expansion body, so that the user has this multi-part expansion anchor available as an assembly part and can install it as a whole.

Preferably, a stop portion for the expansion sleeve is provided on one end of the expansion sleeve facing away from the expansion body, thus limiting the axial movement of the expansion sleeve in a direction facing away from the expansion body along the longitudinal axis of the expansion anchor. In the case of a stud anchor in which the expansion body is configured on one free end of the stud body, the stop portion is advantageously formed by a radially projecting shoulder that is at a distance from the expansion body. As an alternative, an additional component such as, for example, a washer, can be fastened, for instance, positively as a stop element onto a stud body or onto a rod element that can be joined to the expansion body, said stop element having a stop section for the expansion sleeve.

For purposes of simple and economical production of the expansion anchor, the expansion cone is advantageously made of metal by a cold-molding process. It is also advantageous for the expansion cone to be provided with an indentation on its end facing away from the expansion sleeve, as a result of which, on the one hand, material is saved during the production of the expansion body and, on the other hand, a compartment is formed for the drilling dust and drilling debris that collects at the bottom of the drilled hole.

The expansion sleeve is advantageously made of sheet steel in a stamping/bending process. In order to improve the adhesion of the expansion sleeve to the wall of the drilled hole, the outside of the expansion sleeve is advantageously provided with a structure and especially advantageously with elevations projecting towards the outside that increase the friction between the expansion sleeve and the wall of the drilled hole, thus preventing undesired turning of the expansion sleeve, especially at the beginning of the process of installing the expansion anchor.

### BRIEF DESCRIPTION OF THE DRAWINGS

The invention will be explained below with reference to embodiments. The following is shown:

FIG. 1 a side view of a first embodiment of an expansion anchor;

FIG. 2 a partial section through the expansion body of the expansion anchor of FIG. 1;

FIG. 3 a view of the expansion anchor along line in FIG. 1;

FIG. 4 a view of the expansion sleeve analogous to FIG. 3;

FIG. 5 a partial section of a second embodiment of an expansion anchor;

FIG. 6 a view of the expansion anchor along line VI-VI in FIG. 5; and

FIG. 7 a partial side view of a third embodiment of an expansion anchor.

### DETAILED DESCRIPTION

Fundamentally, the same parts are designated with the same reference numerals in the figures.

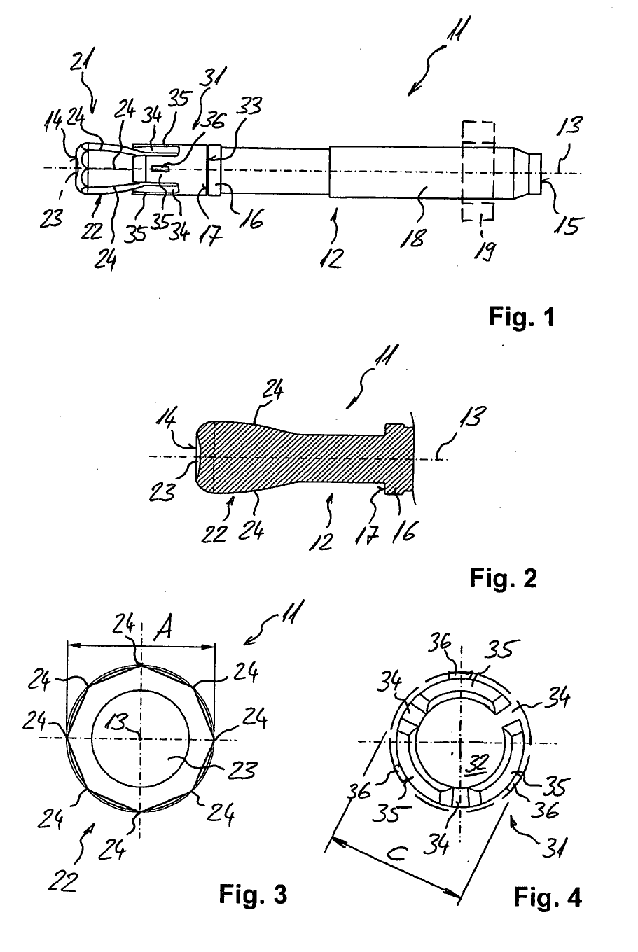

The multi-part expansion anchor 11 shown in FIGS. 1 through 4 comprises a stud body 12 with a longitudinal axis 13 whose first end 14 has an expansion body 21 as well as—adjacent thereto in the direction of the second end 15 of the stud body 12—an expansion sleeve 31 that defines an interior 32. Adjacent to the second end 15, the stud body 12 has a threaded section 18 for a nut 19 indicated here by a broken line.

As its elements, the expansion sleeve 31—as a first part of the expansion anchor 11—has three, that is to say, an odd number of expansion tabs 35 separated from each other by lengthwise slots 34. The expansion sleeve 31 surrounds areas of the stud body 12 adjacent to the expansion body 21. At a distance from the expansion body 21, the stud body 12 has a shoulder 16 that forms a stop portion 17 for the expansion sleeve 31 on one end 33 of the expansion sleeve 31 facing away from the expansion body 21. On each of the expansion tabs 35, there is a radially projecting retaining lug 36 that, when the expansion anchor 11 is inserted into the drilled hole, comes into contact with the wall of the drilled hole and prevents the expansion sleeve 31 from turning along while it is expanding.

As a second part of the expansion anchor 11, the expansion body 21 is arranged coaxially to the longitudinal axis 13 of the expansion sleeve 31 and it can be pulled into the interior 32 of the expansion sleeve 31. The expansion body 21 has a conical portion 22 that serves to radially widen the expansion sleeve 31 and that tapers in the direction of the expansion sleeve 31 or in the direction of the second end 15 of the stud body 12. The expansion body 21 is provided with an indentation 23 on its free end.

As its elements, the conical portion 22 of the expansion body 21 has eight, that is to say, an even number of edges 24 running along the longitudinal axis 13, and they run curved towards the outside. The conical portion 22 of the expansion body 21 has a polygonal cross section that has a maximum outer circle diameter A that runs through the edges 24 running along the longitudinal axis 13 and that is 0.9 to 1.1 times the value of a maximum outer circle diameter C defined by the expansion sleeve 31.

After the expansion anchor 11 has been installed in a previously drilled hole, the stud body is moved axially in the direction of the longitudinal axis 13, for example, by means of the nut 19 that is in contact with an add-on component, whereby the expansion body 21 is pulled into the expansion sleeve 31 and, in this process, the expansion sleeve 31 is widened radially in order to anchor the radial expansion anchor 11 in the drilled hole.

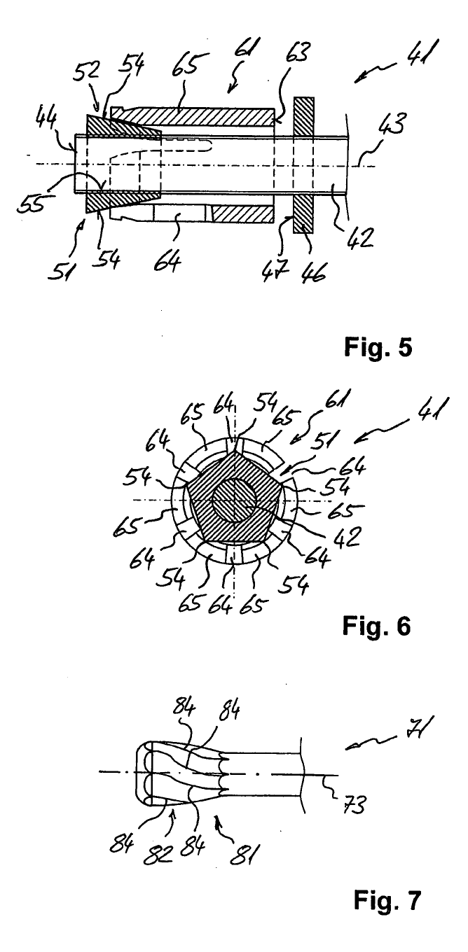

The multi-part expansion anchor 41 shown in FIGS. 5 and 6 comprises a threaded rod provided with an external thread as the stud element 42 that defines a longitudinal axis 43. An expansion body 51 is screwed onto the first end 44 of said stud element and, adjacent thereto, an expansion sleeve 61 that defines an interior is provided in the direction of the other end of the stud element 12.

As a first part of the expansion anchor 41, the expansion sleeve 61 has, as its elements, six, that is to say an even number of expansion tabs 65 separated from each other by lengthwise slots 64. The expansion sleeve 61 surrounds areas of the stud element 42, adjacent to the expansion body 51. At a distance from the expansion body 51, a ring disk 46 is fastened onto the stud element 42, said ring disk forming a stop portion 47 for the expansion sleeve 61 on one end 63 of the expansion sleeve 61 facing away from the expansion body 51.

As a second part of the expansion anchor 41, the expansion body 51 is arranged coaxially to the longitudinal axis 43 relative to the expansion sleeve 61 and it can be pulled into the interior of the expansion sleeve 61. The expansion body 51 has a conical portion 52 that serves to radially widen the expansion sleeve 61 and that tapers in the direction of the expansion sleeve 61 or in the direction of the other end of the stud body 42. As its elements, the conical portion 52 of the expansion body 51 has five, that is to say, an odd number of edges 54 running along the longitudinal axis 43, said edges 54 running linearly.

As a connecting means for a stud element 42 that is provided with an external thread, the expansion body 51 also has a bore 55 in which an internal thread is provided as a fastening means for the stud element 42, and the external thread of the stud element 42 can be screwed into said internal thread.

As an alternative, the stud element 42 can be a separate part of the expansion anchor 41 that the user can shorten as needed, and can then screw into the expansion body 51.

In FIG. 7, the expansion body 81 of the expansion anchor 71 is torsioned in the area of the conical portion 82 along the longitudinal axis 73. The edges 84 running along the longitudinal axis 73 run correspondingly twisted along the conical portion 82. For the rest, the features of the expansion anchor 71 essentially match the features of the previously described expansion anchor 11.

What is claimed is:

1. A multi-part expansion anchor comprising:
a first part having an expansion sleeve having as first elements several expansion tabs separated from each other by elongated slots; and
a second part having an expansion body pullable into the expansion sleeve, the expansion body having a conical portion for radially widening the expansion sleeve, the conical portion having as second elements edges running along a longitudinal axis, one of the first and second parts having an even number of the respective first or second elements, while the other of the first and second parts having an odd number of the respective first or second elements.

2. The expansion anchor as recited in claim 1 wherein the expansion body has an even number of edges running along the longitudinal axis while the expansion sleeve has an odd number of expansion tabs.

3. The expansion anchor as recited in claim 1 wherein a cross section of the conical portion of the expansion body has a maximum outer circle diameter formed by the edges running along the longitudinal axis, the maximum outer circle diameter being 0.8 to 1.4 times a value of a further maximum outer circle diameter defined by the expansion sleeve.

4. The expansion anchor as recited in claim 1 wherein the edges of the conical portion of the expansion body running along the longitudinal axis are curved.

5. The expansion anchor as recited in claim 1 wherein the expansion body is torsioned along the longitudinal axis, at least in the area of the conical portion.

6. The expansion anchor as recited in claim 1 wherein the expansion body is provided on one free end of a stud body and the expansion sleeve surrounds the stud body at least in certain areas.

7. The expansion anchor as recited in claim 1 wherein the expansion body has a connector for a stud element.

8. The expansion anchor as recited in claim 7 wherein the connector includes a bore in the expansion body in which a fastener is provided for the stud element.

9. The expansion anchor as recited in claim 8 wherein the fastener is an internal thread into which an external thread of the stud element can be screwed.

10. The expansion anchor as recited in claim 7 further comprising a stud element joined to the expansion body.

11. The expansion anchor as recited in claim 1 wherein the expansion sleeve has a stop portion for the expansion sleeve on one end of the expansion sleeve facing away from the expansion body.
